(19) United States
(12) Patent Application Publication
(10) Pub. No.: US 2007/0031809 A1
(43) Pub. Date: Feb. 8, 2007

(54) Duo caroling doll with rotating head

(76) Inventor: Kuo-Jui Wei, Taipei City (TW)

Correspondence Address: PRO-TECHTOR INTERNATIONAL SERVICES, 20775 NORADA CT., SARATOGA, CA, 95070, US

(21) Appl. No.: 11/371,647

(22) Filed: Mar. 9, 2006

(30) Foreign Application Priority Data
Aug. 5, 2005 (CN) 200520111396.3

(51) Int. Cl. G09B 25/00

(52) U.S. Cl. 434/393; 434/365; 446/376; 446/268

(57) ABSTRACT

A duo caroling doll with rotating head includes at least two doll bodies. Each doll body includes a bracket, a foldable coat covering the bracket, a sounding device, a plurality of light-emitting diodes (LEDs), a wire, a rotating device, and an external interface. One of the doll bodies further comprises a circuit control device, a power supply, and a switch respectively connected with the circuit control device and the power supply. The circuit control device is respectively connected with the sounding device, the LEDs, the rotating device, the switch, and the external interfaces through the wire. The external interfaces of the two doll bodies are connected together. The circuit control device controls the two doll bodies to operate the sounding device, the LEDs, and the rotating device thereof in turn.

### RELATED APPLICATIONS

The present application is based on, and claims priority from, China Application Serial Number 200520111396.3, filed on Aug. 5, 2005, the disclosure of which is hereby incorporated by reference herein in its entirety.

### FIELD OF THE INVENTION

The present invention relates to a doll, and particularly to a doll which is easily carried, conveniently shipped, simply assembled, and has a plurality of doll bodies with carols singing and lights shining in turn.

### BACKGROUND OF THE INVENTION

The conventional music singing doll offers only a single synthesized vocal and cannot sing duo or trio carols and songs having multiple vocal parts.

Besides, due to frequency and convenience of international commerce and advantageous manufacturing conditions, many products, especially dolls, are fabricated in one place and sold in another, even different countries. Therefore, shipment between a fabrication location and a sale location is long-distance, often international. Reducing shipping cost is thus very important, and one way to reduce shipping cost is to reduce the product's volume.

### SUMMARY OF THE INVENTION

An object of the present invention is to provide a doll which is easily carried, conveniently shipping, simply assembled, and has a plurality of doll bodies with carols singing and lights shining in turn.

To achieve the above object, a duo caroling doll with rotating head of the present invention includes at least two doll bodies. Each doll body includes a bracket and a foldable coat covering the bracket. Each doll body further comprises a sounding device, a plurality of light-emitting diodes (LEDs), a wire, a rotating device, and an external interface. One of the doll bodies further comprises a circuit control device, a power supply, and a switch respectively connected with the circuit control device and the power supply. The circuit control device is respectively connected with the sounding device, the LEDs, the rotating device, the switch, and the external interface through the wire. The external interfaces of the two doll bodies are connected together. The circuit control device controls the two doll bodies to operate the sounding device, the LEDs, and the rotating device thereof in turn.

The bracket is assembled through insertion. An inserted portion of the bracket includes two hollow circular sleeves. One sleeve is disposed with a protrusion, and the other sleeve is defined with an L-shaped slot, wherein a head portion of the slot is a straight slot and a tail portion of the slot is tapered. The protrusion is inserted into the head portion of the L-shaped slot and then is rotated to insert into the tail portion of the L-shaped slot.

The foldable coat is in the shape of a human or animal.

The switch includes a select-switch, an optical control switch, and a push-button switch. The select switch includes three selections, wherein at the first selection, the optical control switch works, at the second selection, the push-button switch works, and at the third selection, neither the optical control switch nor the push-button switch work.

The LEDs are disposed below cheeks of the heads of the doll bodies.

The rotating device includes upper and lower portions, wherein the lower portion is fixed to the bracket, the upper portion is fixed to the head of the doll body and fixed to one motor. The motor is connected to and is controlled by the circuit control device so that the motor rotates the upper portion right and left at an angle relative to the lower portion.

These and other embodiments, aspects, and features of the invention are better understood from a detailed description of the preferred embodiments of the invention, which are further described below in conjunction with the accompanying figures.

### BRIEF DESCRIPTION OF THE DRAWINGS

FIG. 1 is a perspective view of a duo caroling doll with rotating head of the present invention;

FIG. 2 is a perspective view of a bracket of the duo caroling doll with rotating head of the present invention;

FIG. 3 is an enlarged view of the part of the bracket of FIG. 2 showing the bracket being disassembled;

FIG. 4 is an assembled view of FIG. 3;

FIG. 5 is a perspective view of a head assembled with a rotating device of the duo caroling doll with rotating head of the present invention; and

FIG. 6 is a circuit diagram of the duo caroling doll with rotating head of the present invention.

### DETAILED DESCRIPTION OF THE PREFERRED EMBODIMENT

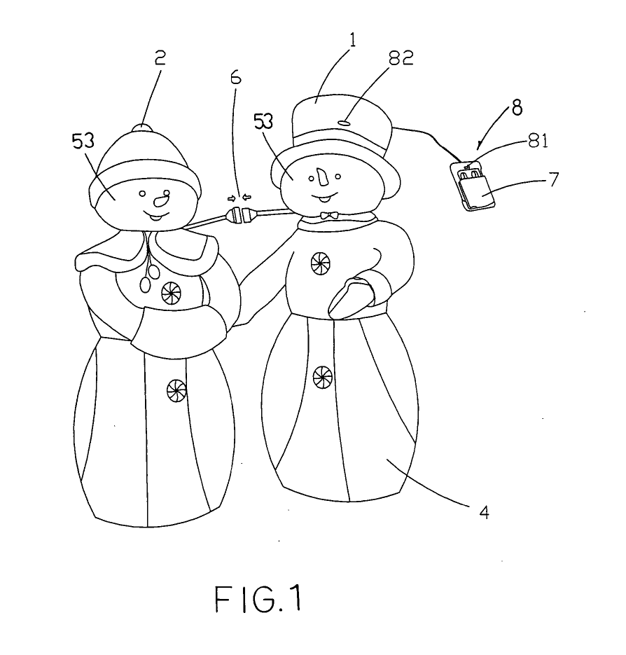

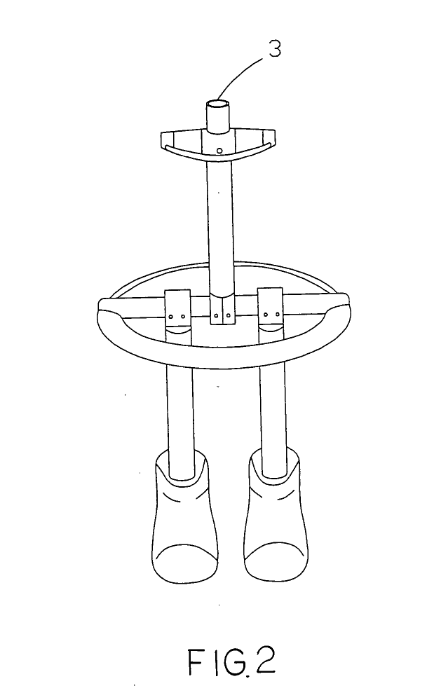

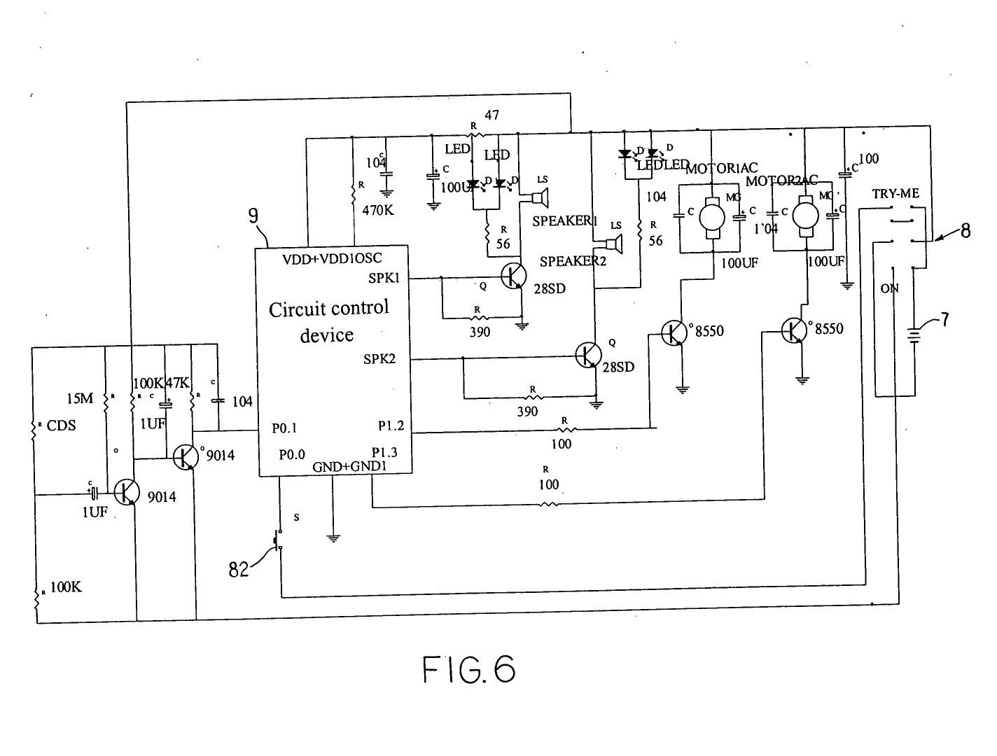

Referring to FIGS. 1-4, a duo caroling doll with rotating head of the present invention includes at least two doll bodies 1 and 2. Each doll body includes a bracket 3 and a coat 4 covering the bracket 3. The coat 4 may be shaped as a human or animal. Each doll body includes a sounding device (not shown), a plurality of light-emitting diodes (LEDs)(not shown), a wire (not shown), a rotating device 5, and an external interface 6. One of the doll bodies 1, further includes a circuit control device 9 (as show in FIG. 6), a power supply 7, and a switch 8, respectively connected with the circuit control device and the power supply. The circuit control device 9 is respectively connected with the sounding device, the LEDs, the rotating device 5, the switch 8, and the external interface 6 through the wire and is shielded by the coat 4. The external interfaces 6 of the two doll bodies are connected together. The circuit control device 9 controls the two doll bodies to operate the sounding device, the LEDs, and the rotating device in turn.

In accordance with the arrows of FIG. 1, the external interfaces 6 are inserted together. Therefore, the circuit control device 9 of the doll body 1 can control both doll bodies 1 and 2. For example, doll body 1 can be controlled to sing a serenade as a man or boy while the LEDs beneath cheeks of the doll body 1 shine, thereby blushing. At the same time, the circuit control device 9 may control a motor to rotate the head of the doll body right and left. Referring to FIG. 6, the circuit control device 9 controls the speaker 1 and the motor 1 disposed at the doll body 1. After the doll body 1 finishes singing, the circuit control device 9 controls the speaker 2 and motor 2 disposed at the doll body 2 to operate such that the doll bodies 1 and 2 shine, sound and rotate in turn as described above.

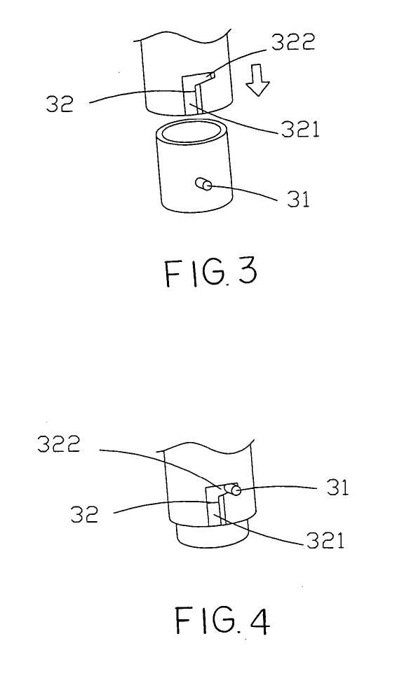

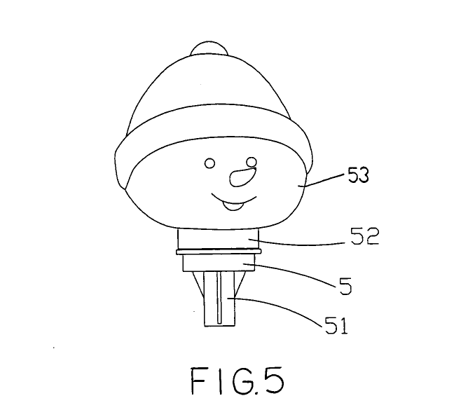

Referring to FIG. 3, the bracket 3 is assembled through insertion. The insertion portion of the bracket 3 includes two hollow circular sleeves. One sleeve is disposed with a protrusion 31. The other sleeve is defined with an L-shaped slot 32. A head portion 321 of the slot 32 is a straight slot. A tail portion 322 of the slot 32 is a tapered slot. The protrusion 31 is inserted into the head portion 321 of the L-shaped slot and then is rotated to insert into the tail portion 322 of the L-shaped slot, as shown in FIG. 4. Thus, the insertion operation is simple and easy. Of course, the bracket 3 may be assembled in other manners. Since the present invention adopts the bracket 3 assembled in the insertion manner, when the bracket 3 is not inserted to connect, the present invention has a small volume. Furthermore, the foldable coat 4 is small after being folded. Thus, the present invention is compact before assembly and so is convenient to ship.

Referring to FIG. 5, the rotating device 5 of the doll includes upper and lower portions. The lower portion 51 is fixed to the bracket 3. The upper portion 52 is fixed to the head 53 of the doll body and to one motor (i.e., motor 1 or motor 2). The motor is connected to and is controlled by the circuit control device 9. The motor rotates the upper portion right and left relative to the lower portion, thus rotating the head.

The switch includes a select-switch, an optical control switch, and a push-button switch. Referring to FIGS. 1 & 6, the select-switch 81 at least includes three selections: ON, TRY-ME and OFF. At the ON selection, the optical control switch works and when it perceives motion, the doll body starts or stops singing. At the TRY-ME selection, the push-button switch works and when the push-button switch 82 disposed at the head of the doll body 1 is pressed, the doll body is controlled to operate. At the OFF selection, the doll body stops motion and the optical control switch and the push-button switch do not work.

The preferred embodiments, aspects, and features of the present invention have been described in detail. It will be apparent to those skilled in the art that numerous variations, modifications, and substitutions may be made without departing from the spirit of the invention as disclosed and further claimed below.

What is claimed is:

1. A duo caroling doll with rotating head comprising at least two doll bodies, each doll body comprising a bracket, a foldable coat covering the bracket, a sounding device, a plurality of light-emitting diodes (LEDs), a wire, a rotating device and an external interface, one of the doll bodies further comprising a circuit control device, a power supply and a switch respectively connected with the circuit control device and the power supply; the circuit control device is respectively connected with the sounding device, the LEDs, the rotating device, the switch, and the external interfaces through the wire; the external interfaces of the two doll bodies being connected together, the circuit control device controlling the two doll bodies to operate the sounding device, the LEDs and the rotating device thereof in turn.

2. The duo caroling doll with rotating head as claimed in claim 1, wherein the bracket is assembled through insertion.

3. The duo caroling doll with rotating head as claimed in claim 2, wherein the insertion portion of the bracket includes two hollow circular sleeves, one sleeve is disposed with a protrusion, the other sleeve is defined with an L-shaped slot, a head portion of the slot is a straight slot, a tail portion of the slot is a tapered slot, the protrusion is inserted into the head portion of the L-shaped slot and then is rotated to insert into the tail portion of the L-shaped slot.

4. The duo caroling doll with rotating head as claimed in claim 1, wherein the foldable coat is in the shape of a human or animal.

5. The duo caroling doll with rotating head as claimed in claim 1, wherein the switch includes a select-switch, an optical control switch, and a push-button switch.

6. The duo caroling doll with rotating head as claimed in claim 5, wherein the select-switch includes three selections: at the first selection, the optical control switch works, at the second selection, the push-button switch works, at the third selection, the optical control switch and the push-button switch do not work.

7. The duo caroling doll with rotating head as claimed in claim 1, wherein the LEDs are disposed beneath cheeks of the heads of the doll bodies.

8. The duo caroling doll with rotating head as claimed in claim 1, wherein the rotating device includes upper and lower portions, the lower portion is fixed to the bracket, the upper portion is fixed to the head of the doll body and to one motor; the motor is connected to and is controlled by the circuit control device so that the motor rotates the upper portion right and left relative to the lower portion.
